(19) United States
(12) Patent Application Publication
(10) Pub. No.: US 2017/0312894 A1
(43) Pub. Date: Nov. 2, 2017

(54) MAGNETICAL ATTRACTION SOCKET STRUCTURE

(71) Applicant: Chien-Ju Chu, Taichung City (TW)

(72) Inventor: Chien-Ju Chu, Taichung City (TW)

(21) Appl. No.: 15/140,504

(22) Filed: Apr. 28, 2016

(51) Int. Cl. B25B 13/48; B25B 23/12; B25B 13/06

(52) U.S. Cl. CPC B25B 13/483; B25B 13/06; B25B 23/12

(57) ABSTRACT

A magnetic attraction socket structure includes a socket body and a magnetic attraction assembly mounted inside the socket body. The socket body includes an installation section formed therein at a top of which a stepped surface is formed. A circumferential groove is formed in an inner circumference of the socket body to correspond to a bottom of the installation section for receiving and holding an elastic ring clip therein. The magnetic attraction assembly has a top positioned against the stepped surface of the socket body. The magnetic attraction assembly includes an insulation jacket and an annular magnetic body, in which the insulation jacket having no permeability includes a receiving hole to receive the annular magnetic body to fit therein. The insulation jacket includes a stop on an inner circumference of the receiving hole for retaining the annular magnetic body in position.

### (a) TECHNICAL FIELD OF THE INVENTION

The present invention relates generally to the field of mounting/dismounting technology, and more particularly to a magnetic attraction socket structure for mounting/dismounting a spark plug.

### (b) DESCRIPTION OF THE PRIOR ART

Various sockets dedicated for spark plugs have been proposed, such as those disclosed in patent documents, U.S. Pat. No. 5,960,682, Taiwan Patent No. 372212 and 1325353, and Taiwan Utility Models M299054 and M446070, which are provided for temporarily holding a spark plug in a socket by means of attraction achieved with a magnetic member or clamping with a resilient clip in order to facilitate installation and removal of the spark plug.

These devices, however, have certain drawbacks in the designs thereof, often causing troubles to a user operating such devices. Brief discussions are given below.

For a device that uses a resilient clip to hold a spark plug, since the sizes and shapes of spark plugs provided by different manufacturers are generally inconsistent with each other. A single clip may not satisfy different all the specifications, so that the expandability thereof is limited and the effectiveness of clamping would be poor if the specification of a spark plug to be held does not completely match. Further, the clip that is generally made of a metal would suffer material fatigue after being used for a long while, eventually affecting the effectiveness of clamping.

For attraction achieved with a magnetic member, since the magnetic member is not directly fixed inside the socket and must be attached thereto by an additional insulation jacket. The jacket is generally made of plastics and may becomes deformed or detaching due to high temperature, oily dirt, or even operation. Jackets made of metals are also available and such jackets suffer undesired displacement resulting for thermal expansion, eventually generating undesired gaps or even totally detaching.

In brief, the structures of the known plug sockets exhibit poor stability and durability, and would readily get loosened or detached, severely affecting the convenience and use in mounting/dismounting spark plugs. Further, it happens the clamping force gets insufficient or the magnetic member gets detached during an operation of mounting/dismounting a spark plug, the spark plug may fall and get hit, causing undesired or unexpected change of a sparking gap of the spark plug and eventually affecting ignition of the spark plug in a subsequent use thereof. Thus, further improvements are necessary.

### SUMMARY OF THE INVENTION

Thus, an object of the present invention is to provide a magnetic attraction socket structure having a broadened range of adaptation and is operable by magnetically attracting a metal flange of a spark plug so as to be adapted to spark plugs provided from different manufacturers thereby enhancing the expandability thereof.

Another object of the present invention is to provide a magnetic attraction socket structure having excellent stability, which effectively maintains the structural stability thereof to prevent undesired separation during use thereof and also to extend the service life thereof.

A further object of the present invention is to provide a magnetic attraction socket structure exhibiting excellent effect of holding for effectively holding a spark plug with extended persistency so as to easily access and remove a spark plug without a potential risk of affecting ignition efficiency of the spark plug.

As such, based on the technique described above, the magnetic attraction socket structure of the present invention makes use of a magnetic attraction assembly that is arranged inside a socket body to attract and be thus attached to a metal flange of a spark plug, making it generally not affected by the differences of size and shape of different products. Further, the magnetic attraction assembly is confined in the socket body by an elastic ring clip and an annular magnetic body of the magnetic attraction assembly is retained and positioned by a stop rim of an insulation jacket so as to effectively maintain structural stability, preventing undesired separation during the use thereof, and also maintaining persistency of magnetic power to thereby extend the service life thereof and enhance the convenience and reliability of mounting/dismounting a spark plug.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic perspective view showing a preferred embodiment of the present invention.

FIG. 2 is an exploded view showing the preferred embodiment of the present invention.

FIG. 3 is a cross-sectional view showing the preferred embodiment of the present invention.

FIG. 4 is a cross-sectional view illustrating the use of the present invention.

FIG. 5 is a cross-sectional view showing another preferred embodiment of the present invention.

FIG. 6 is a cross-sectional view showing a further preferred embodiment of the present invention.

FIG. 7 is a cross-sectional view showing yet a further preferred embodiment of the present invention.

FIG. 8 is a cross-sectional view showing a further preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

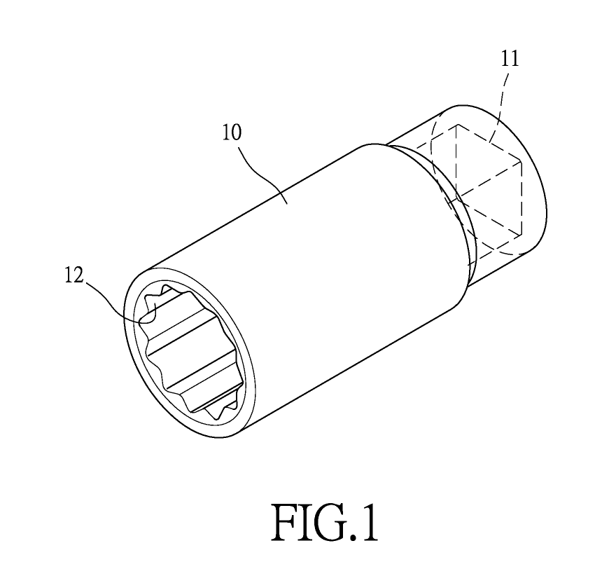

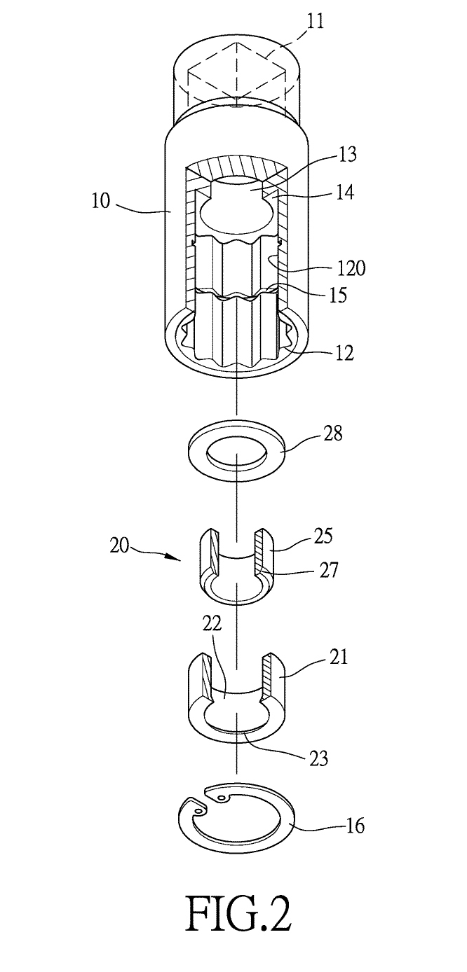

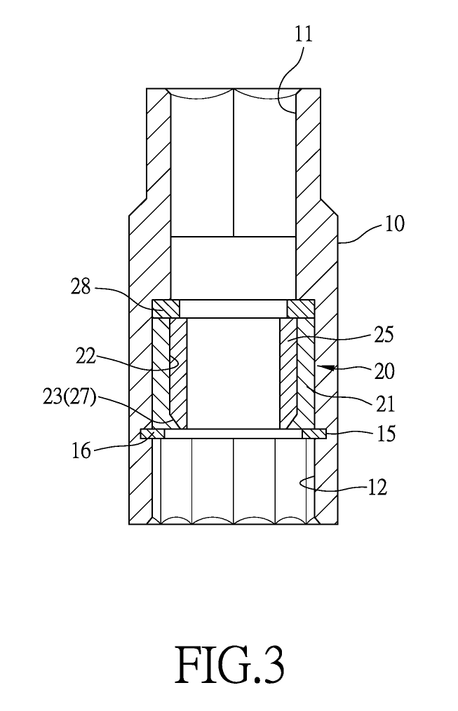

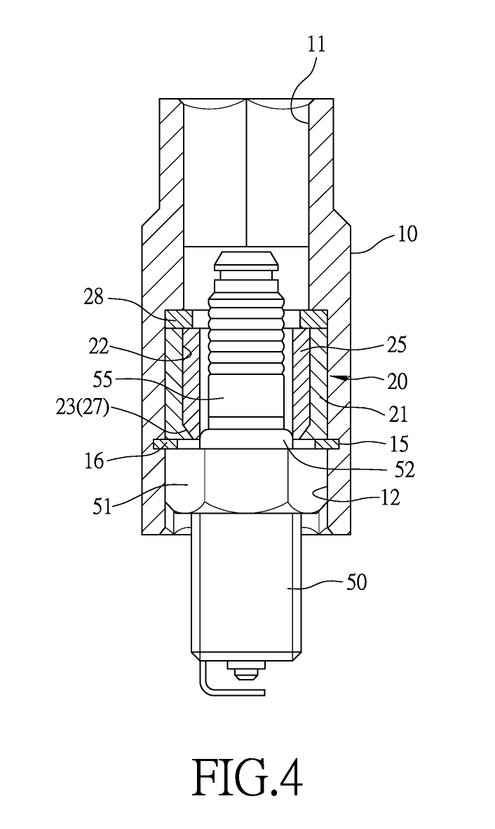

The present invention provides a magnetic attraction socket structure. As shown in FIGS. 1, 2, and 3, the magnetic attraction socket structure comprises a socket body 10 in which a magnetic attraction assembly 20 is mounted for mounting/dismounting a spark plug 50 (see FIG. 4) and allowing the spark plug 50 to be directly picked up and moved in unison therewith.

The socket body 10 has a hollow interior having two opposite ends respectively forming a driven section 11 for being selectively coupled to and driven by an external tool and a fitting section 12 for fitting and coupling to a driving section 51 of the spark plug 50. A through hole 13 is formed between and in communication with the driven section 11 and the fitting section 12 of the socket body 10 for receiving an insulation section 55 of the spark plug 50 therein. The socket body 10 comprises an installation section 120 formed in the fitting section 12 and adjacent to the driven section 11 for installation of the magnetic attraction assembly 20 therein. The installation section 120 has an inside diameter that is greater than an inside diameter of the through hole 13 such that a stepped surface 14 is formed in the socket body 10 at a top end of the installation section 120 for stopping and positioning the magnetic attraction assembly 20. Further, the socket body 10 comprises a circumferential groove 15 formed in an inside surface thereof at a location corresponding to a bottom of the magnetic attraction assembly 20 for selectively receiving and holding an elastic ring clip 16 therein to constrain the magnetic attraction assembly 20 within the installation section 120 of the socket body 10 and prevent the magnetic attraction assembly 20 from undesired movement or detachment.

Further, the magnetic attraction assembly 20 comprises an insulation jacket 21 and an annular magnetic body 25. The insulation jacket 21, which is generally of no permeability, or is not magnetically conductive, comprises a receiving hole 22 formed therein such that the annular magnetic body 25 is fit into and received in the receiving hole 22 of the insulation jacket 21. Further, the insulation jacket 21 comprises an inside stop formed on an inner circumference of the receiving hole 22 to constrain the annular magnetic body 25 from sliding or moving downward. The annular magnetic body 25 has an outer circumferential surface on which an outside stop is formed to correspond to the inside stop of the insulation jacket 21. In the preferred embodiment of the present invention, the inside stop, in the form of a circumferential rim, is formed as a chamfered stop rim 23 on an inner circumference of a bottom of the insulation jacket 21. The outside stop of the annular magnetic body 25 is a chamfered edge 27 corresponding in shape and size to the chamfered stop rim 23 of the insulation jacket 21 such that the annular magnetic body 25 is blocked and retained by the chamfered stop rim 23 of the insulation jacket 21 in the insulation jacket 21 and is thus prevented from sliding downward to get detached. Further, the magnetic attraction assembly 20 comprises a separation pad 28, which is generally of no permeability or is not magnetically conductive and is arranged under the stepped surface 14 of the socket body 10, such that the separation pad 28 is in engagement with and abuts a top surface of the insulation jacket 21 and a part of a top surface of the annular magnetic body 25 to prevent the annular magnetic body 25 from moving upward to get detached therefrom and also to prevent magnetism from being conducted from the annular magnetic body 25 to the socket body 10 to thereby lowering the magnetic attraction force of the magnetic body.

As such, the magnetic attraction assembly 20 arranged inside the socket body 10 may be used to magnetically attract and thus hold a metal flange 52 of the spark plug 50 (see FIG. 4). Further, with an effect of isolation achieved with the insulation jacket 21 and the separation pad 28, the magnetic attraction force is prevented from getting lowered down, whereby a magnetic attraction socket structure having excellent structural stability and persistent magnetic attraction is provided.

To use the present invention, as shown in FIGS. 1 and 4, the fitting section 12 of the socket body 10 is first fit over the driving section 51 and the spark plug 50 such that the insulation section 55 of the spark plug 50 is received through the annular magnetic body 25 of the magnetic attraction assembly 20 with the bottom of the annular magnetic body 25 of the magnetic attraction assembly 20 substantially corresponding to the metal flange 52 on the top of the driving section 51, whereby the annular magnetic body 25 of the magnetic attraction assembly 20 applies a magnetic attraction force to the metal flange 52 of the driving section 51 of the spark plug 50. In this way, in a process of mounting/dismounting the spark plug 50, the spark plug 50 can be temporarily constrained in the socket body 10 to allow the magnetic attraction socket to easily install or pick up the spark plug 50.

The magnetic attraction assembly 20 is constrained in the installation section 120 of the fitting section 12 by the elastic ring clip 16 of the socket body 10 and is thus prevented from getting detached. Further, the annular magnetic body 25 of the magnetic attraction assembly 20 is retained in the insulation jacket 21 by the insulation jacket 21 and the separation pad 28 that are of no permeability and it is possible to prevent the annular magnetic body 25 from getting detached due to temperature, oily contamination, or an operation angle applied thereto and it is also possible to maintain the magnetic force thereof to ensure the attraction power thereof and also for effective removal and pick-up of the spark plug 50, thereby greatly improve the utilization thereof.

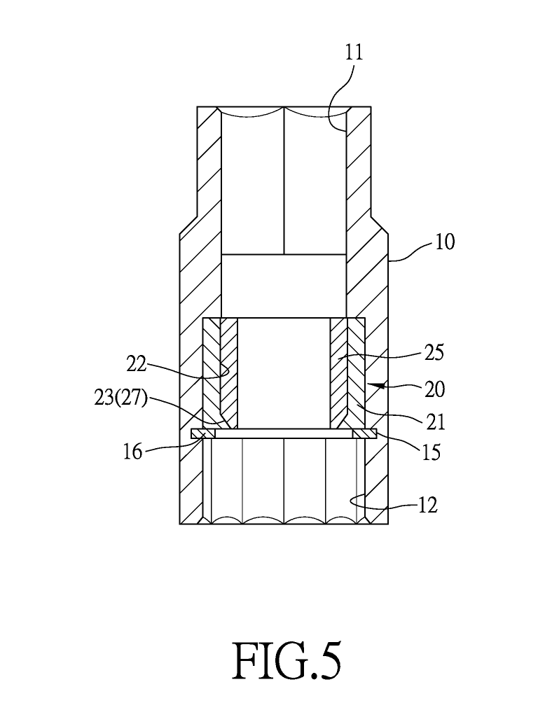

Further, in another embodiment of the present invention, as shown in FIG. 5, the magnetic attraction assembly 20 is arranged such that the top surface of the insulation jacket 21 and a part of the top surface of the annular magnetic body 25 are in direct engagement with the stepped surface 14 of the socket body 10. This similarly helps constrain the annular magnetic body 25 in the interior of the insulation jacket 21 and the same effect and purpose can be achieved.

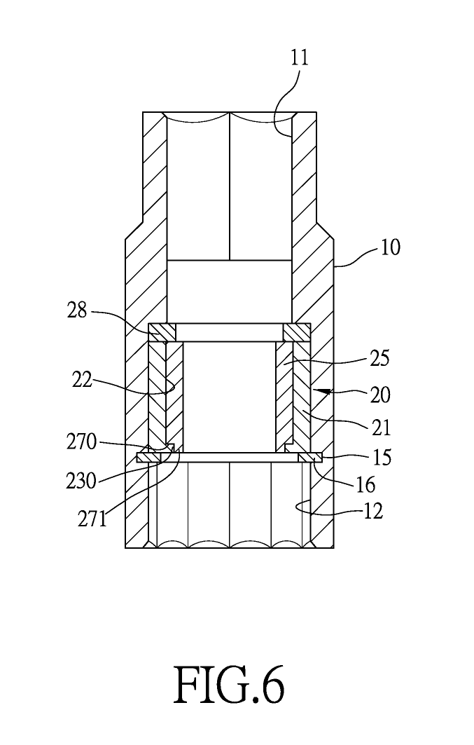

Further, as shown in FIG. 6, a further embodiment of the present invention is shown, in which the inside stop of the insulation jacket 21 is made in the form of a stepped stop rim 230 formed on a bottom of the receiving hole 22 and the annular magnetic body 25 has an outer circumferential surface on which the outside stop is provided in the form as a stepped edge 270 formed in a bottom of the annular magnetic body 25 to correspond to and engage with the stepped stop rim 230 of the insulation jacket 21 so that the annular magnetic body 25 is constrained by the stepped stop rim 230 of the insulation jacket 21 in the interior of the insulation jacket 21 without being detached. Further, the annular magnetic body 25 also comprises a projection 271 formed on the bottom thereof and projecting beyond the bottom of the insulation jacket 21 to apply an enhanced magnetic attraction force to the metal flange 52 of the driving section 51 of the spark plug 50.

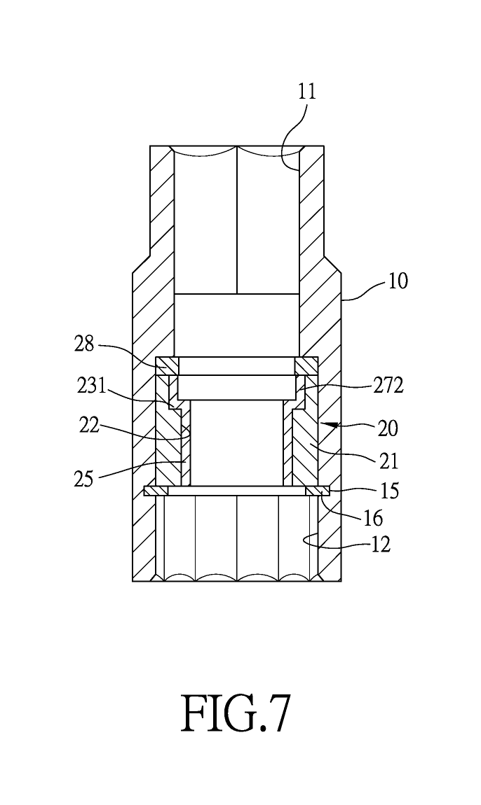

Further, in a further embodiment of the present invention, as shown in FIG. 7, the inside stop of the insulation jacket 21 comprises an expanded hole section 231 formed in an upper portion of the receiving hole 22 and the outside stop formed on the outer circumferential surface of the annular magnetic body 25 comprises a large diameter section 272 that is formed on the annular magnetic body 25 to correspond to the expanded hole section 231 of the insulation jacket 21 such that the annular magnetic body 25 can be supported by having the large diameter section 272 positioned on and retained by the expanded hole section 231 of the insulation jacket 21 to prevent the annular magnetic body 25 from moving downward and separating from the insulation jacket 21.

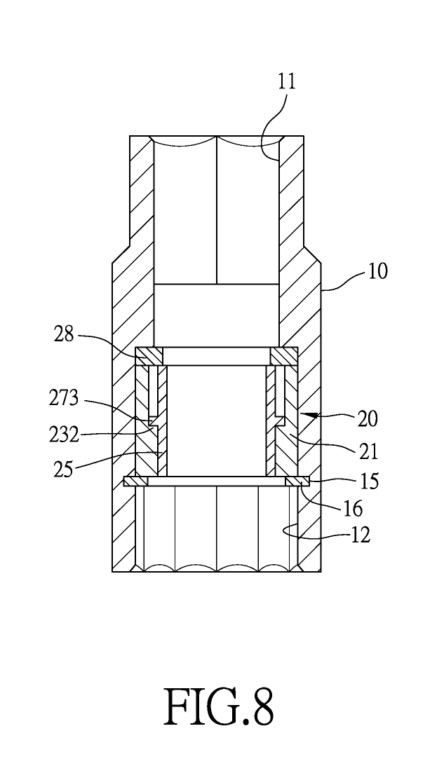

In addition, in a further embodiment of the present invention, as shown in FIG. 8, the inside stop of the insulation jacket 21 comprises a necked section 232 formed on a middle portion of the receiving hole 22 and the outside stop that is formed on the outer circumferential surface of the annular magnetic body 25 comprises a circumferential projecting rim 273 provided on a middle portion of the annular magnetic body 25 to correspond to the necked section 232 of the insulation jacket 21 such that the annular magnetic body 25 is supported by having the circumferential projecting rim 273 positioned on and retained by the necked section 232 of the insulation jacket 21 to prevent the annular magnetic body 25 from moving downward and separating from the insulation jacket 21.

With the above described arrangements, the present invention provides a magnetic attraction socket that uses a magnetic attraction assembly 20 arranged inside a socket body 10 to attract and hold a metal flange 52 of a driving section 51 of a spark plug 50, making it not limited size and shape of specific products and thus enhancing the expandability and adaptability. Further, the magnetic attraction assembly 20 is retained by an elastic ring clip 16 inside the socket body 10 without undesired movement and an annular magnetic body 25 of the magnetic attraction assembly 20 is also fixed by a stop of the insulation jacket 21 to thereby maintain structural stability, preventing separation during the use thereof and improving sustainability of the magnetic force maintained for an extended period of time, whereby the life span thereof is extended; degrading of the attraction force or magnetic force during the use thereof is avoided; operation effectiveness can be maintained; convenience and reliability of mounting/dismounting a spark plug is enhanced; dropping of the spark plug can be avoided to ensure good ignition efficiency.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A magnetic attraction socket structure for holding a spark plug, comprising:
a socket body, which has a hollow interior having two opposite ends respectively forming a driven section adapted to be coupled to and driven by an external tool and a fitting section adapted to fit to and rotate a spark plug, the socket body comprising an installation section formed in the fitting section and adjacent to the driven section, the installation section comprising a stepped surface formed at a top thereof, the socket body comprising a circumferential groove formed in an inside surface thereof at a location corresponding to a bottom of the installation section for selectively receiving and holding an elastic ring clip therein; and
a magnetic attraction assembly, which is mounted in the installation section of the socket body, the magnetic attraction assembly having a top positioned against the stepped surface of the socket body, the magnetic attraction assembly comprising an insulation jacket and an annular magnetic body, wherein the insulation jacket, which is of no permeability, comprises a receiving hole formed therein for receiving the annular magnetic body to fit therein, the insulation jacket comprising an inside stop formed on an inner circumference of the receiving hole, the annular magnetic body having an outer surface on which an outside stop is formed to correspond to and retain the inside stop.

2. The magnetic attraction socket structure according to claim 1, wherein a through hole is formed between and in communication with the driven section and the fitting section of the socket body for receiving the insulation section of the spark plug therein.

3. The magnetic attraction socket structure according to claim 1, wherein the inside stop of the insulation jacket of the magnetic attraction assembly comprises a chamfered stop rim formed on an inner circumference of a bottom of the insulation jacket and the outside stop of the annular magnetic body comprises a chamfered edge that is formed on an outer surface of a bottom thereof and corresponds to the chamfered stop rim of the insulation jacket such that the annular magnetic body is retained in the insulation jacket by the chamfered stop rim of the insulation jacket.

4. The magnetic attraction socket structure according to claim 1, wherein the inside stop of the insulation jacket of the magnetic attraction assembly comprises a stepped stop rim formed in a bottom thereof and the outside stop of the annular magnetic body comprises a stepped edge formed in a bottom of annular magnetic body to correspond to and engage with the stepped stop rim of the insulation jacket, the annular magnetic body comprising a projection formed on the bottom thereof and projecting beyond the bottom of the insulation jacket to allow the annular magnetic body to be retained in the insulation jacket by the stepped stop rim of the insulation jacket.

5. The magnetic attraction socket structure according to claim 1, wherein the inside stop of the insulation jacket of the magnetic attraction assembly comprises an expanded hole section formed in an upper portion of the receiving hole and the outside stop of the annular magnetic body comprises a large diameter section formed on the annular magnetic body to correspond to the expanded hole section of the insulation jacket, so that the annular magnetic body is retained in the insulation jacket by the expanded hole section of the insulation jacket.

6. The magnetic attraction socket structure according to claim 1, wherein the inside stop of the insulation jacket of the magnetic attraction assembly comprises a necked section formed in a middle portion of the receiving hole and the outside stop on the outer circumferential surface of the annular magnetic body comprises a circumferential projecting rim provided on a middle portion of the annular magnetic body to correspond to the necked section of the insulation jacket, so that the annular magnetic body is retained in the insulation jacket by the necked section of the insulation jacket.

7. The magnetic attraction socket structure according to claim 1, wherein the magnetic attraction assembly comprises a separation pad that is of no permeability and arranged under the stepped surface of the socket body, the separation pad being in engagement with and abutting a top surface of the insulation jacket and a part of a top surface of the annular magnetic body to prevent the annular magnetic body from moving upward to get detached therefrom.

8. The magnetic attraction socket structure according to claim 3, wherein the magnetic attraction assembly comprises a separation pad that is of no permeability and arranged under the stepped surface of the socket body, the separation pad being in engagement with and abutting a top surface of the insulation jacket and a part of a top surface of the annular magnetic body to prevent the annular magnetic body from moving upward to get detached therefrom.

9. The magnetic attraction socket structure according to claim 4, wherein the magnetic attraction assembly comprises a separation pad that is of no permeability and arranged under the stepped surface of the socket body, the separation pad being in engagement with and abutting a top surface of the insulation jacket and a part of a top surface of the annular magnetic body to prevent the annular magnetic body from moving upward to get detached therefrom.

10. The magnetic attraction socket structure according to claim 5, wherein the magnetic attraction assembly comprises a separation pad that is of no permeability and arranged under the stepped surface of the socket body, the separation pad being in engagement with and abutting a top surface of the insulation jacket and a part of a top surface of the annular magnetic body to prevent the annular magnetic body from moving upward to get detached therefrom.

11. The magnetic attraction socket structure according to claim 6, wherein the magnetic attraction assembly comprises a separation pad that is of no permeability and arranged under the stepped surface of the socket body, the separation pad being in engagement with and abutting a top surface of the insulation jacket and a part of a top surface of the annular magnetic body to prevent the annular magnetic body from moving upward to get detached therefrom.
